(19) United States
(12) Patent Application Publication
(10) Pub. No.: US 2018/0004649 A1
(43) Pub. Date: Jan. 4, 2018

(54) Techniques to Format a Persistent Memory File

(71) Applicant: Intel Corporation, Santa Clara, CA (US)

(72) Inventor: Leena K. Puthiyedath, Portland, OR (US)

(73) Assignee: Intel Corporation, Santa Clara, CA (US)

(21) Appl. No.: 15/200,857

(22) Filed: Jul. 1, 2016

(51) Int. Cl. G06F 12/02; G06F 17/30

(52) U.S. Cl. CPC G06F 12/0238; G06F 17/30076; G06F 2212/202; G06F 2212/152

(57) ABSTRACT

Examples may include techniques to format a persistent memory file. Memory representations of data structures maintained in virtual addresses of a process virtual memory space for a computing device may be received. A file may be formatted to store or map the receive memory representations of the data structures to a persistent memory maintained at one or more memory devices coupled with the computing device. The file format to require no serialization or marshalling transformations to write or map memory representations of the data structures to the persistent memory.

### TECHNICAL FIELD

Examples described herein are generally related to use of persistent memory in a computing system.

### BACKGROUND

Persistent memory may be characterized as a way to store data structures such that the data structures may continue to be accessible using memory instructions or memory application programming interfaces (APIs) even after the process that created or last modified the data structures ends. Persistent memory may be accessed in a similar manner to types of volatile memory used for system memory of a computing system (e.g., dynamic random access memory (DRAM)), but it retains stored data structures across power loss in a similar manner to computer storage (e.g., hard disk drives or solid state drives). Persistent memory capabilities extend beyond an ability to retain stored data structures across power loss. For example, key metadata may also need to be retained across power loss.

### BRIEF DESCRIPTION OF THE DRAWINGS

FIG. 1 illustrates an example system.

FIG. 2 illustrates example representations.

FIG. 3 illustrates an example scheme.

FIG. 4 illustrates an example extended page table mapping.

FIG. 5 illustrates an example apparatus.

FIG. 6 illustrates an example logic flow.

FIG. 7 illustrates an example storage medium.

FIG. 8 illustrates an example computing platform.

### DETAILED DESCRIPTION

Computing systems may utilize memory representations of a data structure that has references or pointers that may be tied to a state of a process instance or process context for applications being executed by compute resources of these computing systems. The memory representation of the data structure may include, but is not limited to, a graph or a binary search tree (BST) that has a linked list with references or pointers in a process virtual address space. Typically, to store the data structure to a file, the memory representation of the data structure needs to be transformed into a serialized format.

Transforming a memory representation of a data structure into a serialized format may be due to storage devices arranged to store a file for the data structure being on an input/output bus that may provide only a block address granularity to computing systems coupled to the input/output buses. Meanwhile, system memory for computing systems may operate using a cache line or byte address granularity access with central processing unit (CPU) load/store instructions. Transforming the memory representation of the data structure to the serialized format may be referred to as serialization or marshalling. In some examples, to compute on the stored file this stored file needs to be transformed (de-serialized or un-marshalled) back to the memory representation of the data structure. Some data structures may have a high complexity and serialization/deserialization of these complex data structures may consume computing system resources such as CPU compute cycles, memory capacity and input/output bandwidth.

According to some examples, persistent memory aware file systems may allow a mapping of files in to a process virtual address space associated with a process context. A value attributed to this type of mapping is that copying data in a file from a storage device directly to system memory may avoid using memory buffers. However, if a format of data in the file is not a same format as a memory representation of the data, the value of direct mapping may be reduced since the data may need to be de-serialized which may require use of memory buffers.

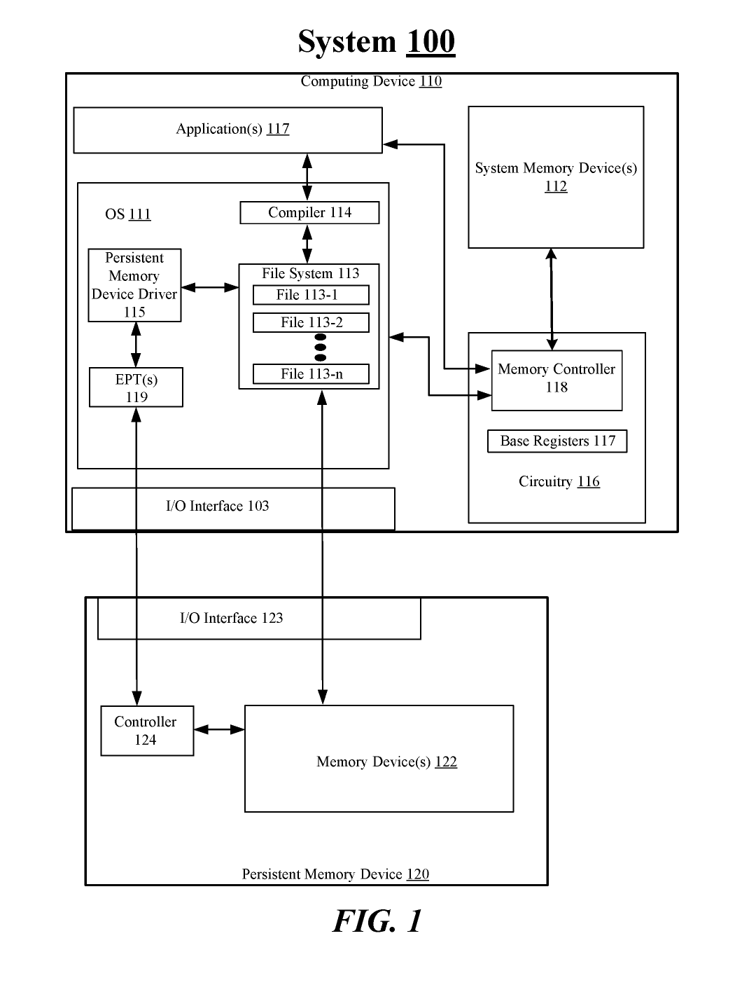

FIG. 1 illustrates an example system 100. In some examples, as shown in FIG. 1, system 100 includes a computing device 110 coupled to a persistent memory device 120 through input/output (I/O) interface 103 and I/O interface 123. Also, as shown in FIG. 1, computing device 110 may include an Operating System (OS) 111, one or more system memory device(s) 112, circuitry 116, and one or more application(s) 117. For these examples, circuitry 116 may be capable of executing various functional elements of computing device 110 such as OS 111 and application(s) 117 that may be maintained, at least in part, within system memory device(s) 112. Circuitry 116 may include host processing circuitry to include one or more central processing units (CPUs) and associated chipsets and/or controllers.

According to some examples, computing device 110 may include, but is not limited to, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof.

According to some examples, as shown in FIG. 1, OS 111 may include a file system 113, and a persistent memory device driver 115. In some examples, as shown in FIG. 1 and described in more detail below, persistent memory device driver 115 may utilize one or more extended page tables (EPT(s)) 119 in cooperation with a controller 124 at persistent memory device 120 to access physical memory pages maintained at one or more memory device(s) 122. OS 111 may be arranged to implement persistent memory device driver 115 to coordinate at least temporary storage of data for a memory representation of a data structure in a file from among files 113-1 to 113-n, where “n” is any whole positive integer >1, to memory device(s) 122 at persistent memory device 120. The data structure, for example, may have originated from or may be associated with executing at least portions of application(s) 117.

In some examples, as described in more detail below, files 113-1 to 113-n may be formatted such that a persistent memory (PM) file representation of a data structure may be included in files 113-1 to 113-n based on a compiler such as compiler 114 generating reference offsets for the data structure included in files 113-1 to 113-n that may then be stored to physical memory pages maintained at memory device(s) 122. These reference offsets may be associated with pointers to a process virtual address space via which a memory representation of the data structure for one or more application(s) such as application(s) 117 may be maintained in system memory supported by system memory device(s) 112. Alternatively, in other examples, files 113-1 to 113-n may be formatted based on registers such as base registers 117 that may be located with or maintained by circuitry 116. Circuitry 116 may utilize base registers 117 along with instructions (e.g., CPU instructions) to de-reference pointers to determine reference offsets for the data structure included in files 113-1 to 113-n that may then be stored to physical memory pages maintained at memory device(s) 122. The de-referenced pointers may have been pointers to a process virtual address space via which a memory representation of the data structure for one or more application(s) such as application(s) 117 may be maintained in system memory supported by system memory device(s) 112. For either of these examples, at least some of the physical memory pages maintained at memory device(s) 122 of persistent memory device 120 may be mapped to files 113-1 to 113-n using EPT(s) 119.

According to some examples, system memory device(s) 112 may store information and commands which may be used by circuitry 116 for processing information. Also, as shown in FIG. 1, circuitry 116 may include a memory controller 118. Memory controller 118 may be arranged to control access to data (e.g., associated with data structures) at least temporarily stored at system memory device(s) 112 for eventual storage in a file to memory device(s) 122 at persistent memory device 120. In some examples, memory device(s) 122 of persistent memory device 120 may include types of memory capable of functionally replacing system memory device(s) 112. For these examples, memory device(s) 122 may store the information and commands which may be used by circuitry 116 for processing information.

In some examples, communications between persistent memory device driver 115 and controller 124 for data stored in memory devices(s) 122 and accessed via files 113-1 to 113-n may be routed through I/O interface 103 and I/O interface 123. I/O interfaces 103 and 123 may be arranged as a Peripheral Component Interconnect Express (PCIe) interface to couple elements of computing device 110 to persistent memory device 120. In another example, I/O interfaces 103 and 123 may be arranged as a Non-Volatile Memory Express (NVMe) interfaces to couple elements of computing device 110 to persistent memory device 120. For this other example, communication protocols may be utilized to communicate through I/O interfaces 103 and 123 as described in industry standards or specifications (including progenies or variants) such as the Peripheral Component Interconnect (PCI) Express Base Specification, revision 3.1a, published in December 2015 (“PCI Express specification” or “PCIe specification”) and/or the Non-Volatile Memory Express (NVMe) Specification, revision 1.2a, published in October 2015 (“NVMe specification”). Although PCIe or NVMe interfaces may typically involve block storage of data, in some examples, data structures stored to persistent memory device 120 may be paged in to system memory device(s) when accessed by circuitry 116.

According to some examples, memory device(s) 122 at persistent memory device 120 may be composed of one or more memory devices or dies which may include various types of volatile and/or non-volatile memory. Volatile memory may include, but is not limited to, random-access memory (RAM), Dynamic RAM (D-RAM), double data rate synchronous dynamic RAM (DDR SDRAM), static random-access memory (SRAM), thyristor RAM (T-RAM) or zero-capacitor RAM (Z-RAM). Non-volatile memory may include, but is not limited to, non-volatile types of memory such as 3-D cross-point memory that may be byte or block addressable. These block addressable or byte addressable non-volatile types of memory may include, but are not limited to, memory that uses chalcogenide phase change material (e.g., chalcogenide glass), multi-threshold level NAND flash memory, NOR flash memory, single or multi-level phase change memory (PCM), resistive memory, nanowire memory, ferroelectric transistor random access memory (FeTRAM), magnetoresistive random access memory (MRAM) memory that incorporates memristor technology, or spin transfer torque MRAM (STT-MRAM), or a combination of any of the above, or other non-volatile memory types.

System Memory device(s) 112 may include one or more chips or dies having volatile types of memory such RAM, D-RAM, DDR SDRAM, SRAM, T-RAM or Z-RAM. However, examples are not limited in this manner, and in some instances, system memory device(s) 112 may include non-volatile types of memory, including, but not limited to, NAND flash memory, NOR flash memory, 3-D cross-point memory, ferroelectric memory, SONOS memory, ferroelectric polymer memory, FeTRAM, FeRAM, ovonic memory, nanowire, EEPROM, phase change memory, memristors or STT-MRAM.

In some examples, the one or more memory devices included in persistent memory device 120 and/or system memory device(s) 112 may be designed to operate in accordance with various memory technologies. The various memory technologies may include, but are not limited to, DDR4 (DDR version 4, initial specification published in September 2012 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), and/or other technologies based on derivatives or extensions of such specifications. The various memory technologies may also include memory technologies currently in development that may include, but are not limited to, DDR5 (DDR version 5, currently in discussion by JEDEC), LPDDR5 (LPDDR version 5, currently in discussion by JEDEC), HBM2 (HBM version 2, currently in discussion by JEDEC), and/or other new technologies based on derivatives or extensions of these developing memory technologies.

According to some examples, the one or more memory devices of memory device(s) 122 or system memory device(s) 112 may be located on one or more dual in-line memory modules (DIMMs). These DIMMs may be designed to function as a registered DIMM (RDIMM), a load reduced DIMM (LRDIMM), a fully-buffered DIMM (FB-DIMM), an unbuffered DIMM (UDIMM) or a small outline (SODIMM). Examples are not limited to only these DIMM designs.

In some examples, memory devices of memory device(s) 122 or system memory device(s) 112 maintained on one or more DIMMs may include all or combinations of types of volatile or non-volatile memory. For example, memory devices of a first type of DIMM may include volatile memory on a front or first side and may include non-volatile memory on a back or second side. In other examples, a second type of DIMM may include combinations of non-volatile and volatile types of memory on either side of this second type of DIMM. In other examples, all memory devices on a given DIMM may be either volatile types of memory or non-volatile types of memory. In other examples, a third type of DIMM may include non-volatile memory and at least some volatile memory and this third type of DIMM may be referred to as a non-volatile DIMM (NVDIMM).

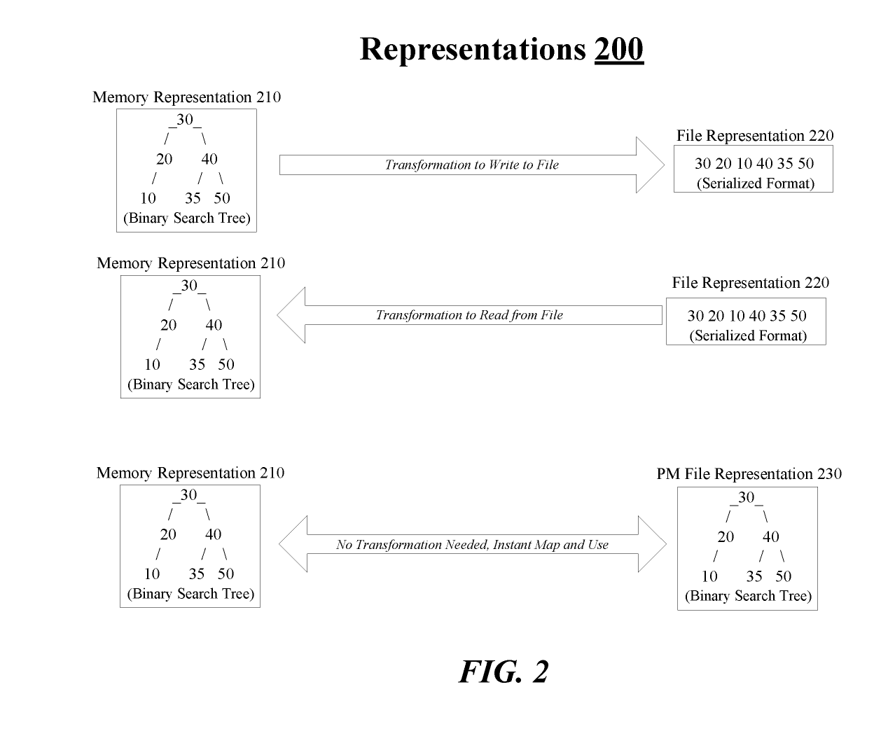

FIG. 2 illustrates example representations 200. In some examples, as shown in FIG. 2, representations may include a memory representation 210, a file representation 220 and a persistent memory (PM) file representation 230. For these examples, memory representation 210 may be a memory representation of a binary search tree data structure having references or pointers tied to a state of a process instance or process context for applications (e.g., application(s) 117 of system 100) being executed by compute resources (e.g., circuitry 116 of system 100). Memory representation 210 may be based on these compute resources being arranged to operate using a cache line or byte address granularity access to maintain this representation in system memory.

According to some examples, file representation 220 may be an example of a serialized format of the binary search tree of memory representation 210 that may be needed to write memory representation 210 to a file when only a block address granularity is allowed over an input/output bus that may couple a storage memory device to the computing resources that generated memory representation 210. For these examples, memory representation 210 may undergo a transformation that may be referred to as serialization or marshalling. Also, when reading file representation 220, a de-serialization or de-marshalling is needed to transform file representation 220's serialized format to the binary search tree data structure of memory representation 210. The binary search tree for memory representation 210 shown in FIG. 2 is a relatively simple data structure. In some examples, far more complex data structures may require compute and/or system memory intensive serializations/de-serializations to transform to/from serialized formats.

According to some examples, PM file representation 230 may be formatted in an example file format to allow dynamic data such as references in the binary search tree included in memory representation 210 to be mapped to virtual addresses of a process virtual address space based on a reference offset. For these examples, no serialization or marshalling transformations may be needed to write or read memory representation 210 to or from a persistent memory device when PM file representation 230 is formatted in the example file format. In some examples, PM file representation 230 in the example file format may include a file view for memory representation 210. For these examples, a given reference offset for the file view may be a starting offset based on which all references in the binary search tree of memory representation 210 may be mapped to virtual addresses of a process virtual address space. As described more below, the file view may be mapped from a file base or reference offset and all pointers to the given process virtual address space may then point to one or more virtual addresses where the file view is mapped.

In some examples, a compiler (e.g., compiler 114) may generate a reference offset for PM file representation 230 that may be associated with a pointer to a process virtual address space of one or more applications that may have generated or use the data structure included in memory representation 210. For these examples, the compiler may generate the reference offset in relation to a file base (herein referred to as a “based pointer”) to determine a starting offset for the references in the binary search tree of memory representation 210 when stored to PM file representation 230. Alternatively or in addition to a compiler, computing resources such as a CPU (e.g., circuitry 116) may support a view base register (e.g., base registers 117) and instructions to de-reference a based pointer for memory representation 210 when mapped from the process virtual address space to PM file representation 230.

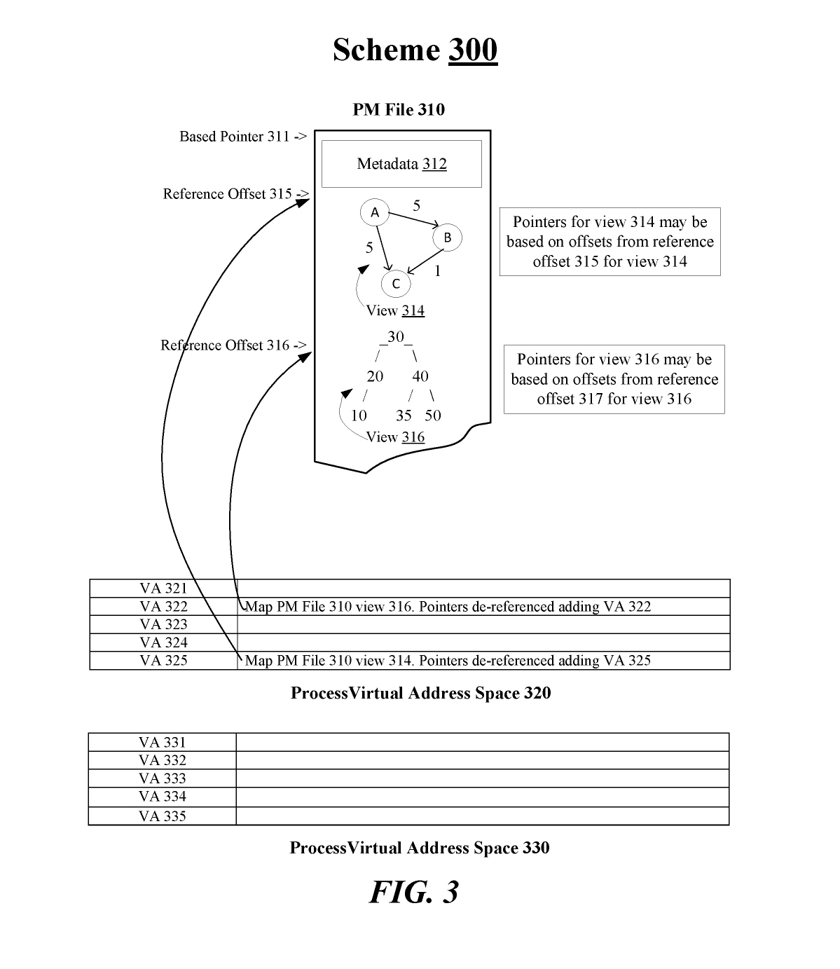

FIG. 3 illustrates an example scheme 300. In some examples, scheme 300 may be for mapping multiple views of a PM file such as a PM file 310 to virtual addresses included in a process virtual address space such as a process virtual address space 320 or a process virtual address space 330. For these examples, as shown in FIG. 3, PM file 310 may include a view 314 mapped to virtual address (VA) 322 of process virtual address space 320 and a view 316 mapped to VA 325 of process virtual address space 320. View 314 may be for a type of data structure such as a graph data structure and view 316 may be for another type of data structure such as a binary search tree. Examples, are not limited to data structures such as graphs or binary search trees, other types of data structures are contemplated such as linked lists, queues, meshes, etc. Also, files with based pointers may include an instruction sequence (in-place executable files).

According to some examples, views 314 and 316 may have respected reference offsets 315 and 317 that serve as starting offsets via which references in data structures for these views may be referenced in relation to a based pointer 311 (e.g., offset 0). For example, reference “A” for the data structure of view 314 may have a starting offset shown in FIG. 3 as reference offset 315 that has a pointer to VA 325 of process virtual address space 320. Reference offset 315 may have a first offset in relation to based pointer 311. Also, other pointers for view 314 may be offsets from reference offset 315 for view 314 that may be pointers to virtual addresses of process virtual address space 320 that may be contiguous with VA 325. In another example, reference “30” for the data structure of view 316 may have a starting offset shown in FIG. 3 as reference offset 317 that has a pointer to VA 322 of process virtual address space 320. Reference offset 317 may have a second offset in relation to based pointer 311. Also, other pointers for view 316 may be offsets from reference offset 317 for view 316 that may be pointers to virtual addresses of process virtual address space 320 that may be contiguous with VA 322.

In some examples, as shown in FIG. 3, multiple views may be included in a PM file such as PM file 310. For these examples, metadata 312 may be included at a beginning of PM file 310. Metadata 312 may include information to indicate a starting offset and a persistent memory unit size of views 314 and 316. Based on this information in metadata 312, a starting offset for reference offsets 315 and 317 may be determined. This may enable reference offsets 315 and 317 to be mapped in to a VA from among VAs 321 to 325 to reference the data structures included in respective views 314 and 316.

According to some examples, a PM file may include a single view. For these examples, the PM file may be mapped from a reference offset of 0 in to a VA from among VAs included in any process virtual address space for a process context. In other words, if PM file 310 were to contain a single view (e.g., just view 314), then a VA from among VAs 321 to 325, VAs 331 to 335 or VAs included in any process virtual address space for the process context may be mapped from based pointer 311 due to based pointer 311 having a reference offset of 0 for PM file 310.

In some examples, de-reference of pointers in a mapped view may be relative to a virtual address that a given view was mapped. For these examples, a based pointer may be the virtual address of start of the given view. As shown in FIG. 3, views 314 and 316 are mapped to different VAs from among VAs 321 to 325. This concept may be extended to different process virtual address spaces, where a same view may be mapped at different virtual addresses. Thus, a based pointer for data structures for a given view may allow these data structures to be shared among any number of different process virtual address spaces.

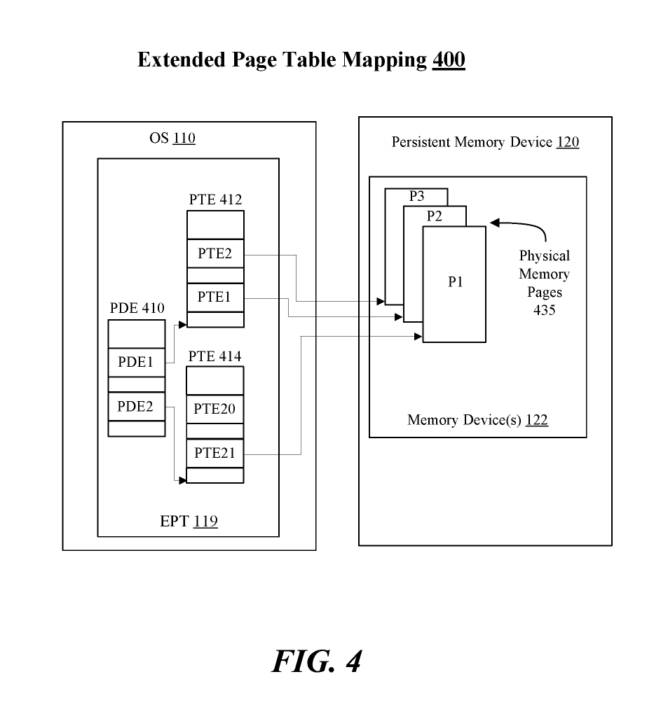

FIG. 4 illustrates an example extended page table mapping 400. In some examples, extended page table mapping 400 includes EPT 119 mapped to physical memory pages 435 maintained at memory device(s) 122 of persistent memory device 120. Examples are not limited to EPT mapping. In some examples, virtual address mapping of persistent memory may be through other mechanisms including, but not limited to, page tables—native and extended, shared virtual memory, etc. that may be used for translation by a system memory controller and/or an input/output memory management unit (MMU).

In some examples, as shown in FIG. 4, EPT 119 may be a two-level EPT. Although this disclosure contemplates use of other multi-level EPTs, for simplicity a two-level EPT for EPT 119 is shown and described for extended page table mapping 400. The two-level EPT 119 may include page directory entry (PDE) table 410 and page table entry (PTE) tables 412 and 414. According to some examples, logic and/or features of OS 110 such as persistent memory device driver 115 may work in cooperation with logic and/or features of persistent memory device 120 such as controller 124 to use EPT 119 to facilitate a mapping of files generated by a file system such as file system 113 to physical memory pages maintained at memory device(s) 122.

In some examples, extended page table mapping 400 may be based on startup or initialization of system 100 that includes a basic input/output system (BIOS) for system 100 (not shown in FIG. 1) indicating presence of an Advanced Configuration and Power Interface (ACPI) table to logic and/or features of OS 111 such as persistent memory device driver 115. The ACPI table may provide information to determine what memory pages maintained at memory device(s) 122 may be available for mapping to files generated by file system 113. The ACPI table may be according to the ACPI specification, version 6.1, published by the Unified Extensible Firmware Interface (UEFI) Forum in January of 2016 (“the ACPI specification”), and/or other derivatives or extensions of the ACPI specification. For example, the ACPI table may be an NVDIMM firmware interface table (NFIT) that provides information to determine that physical memory pages 435 are available for mapping to files generated by file system 113 using EPT 119.

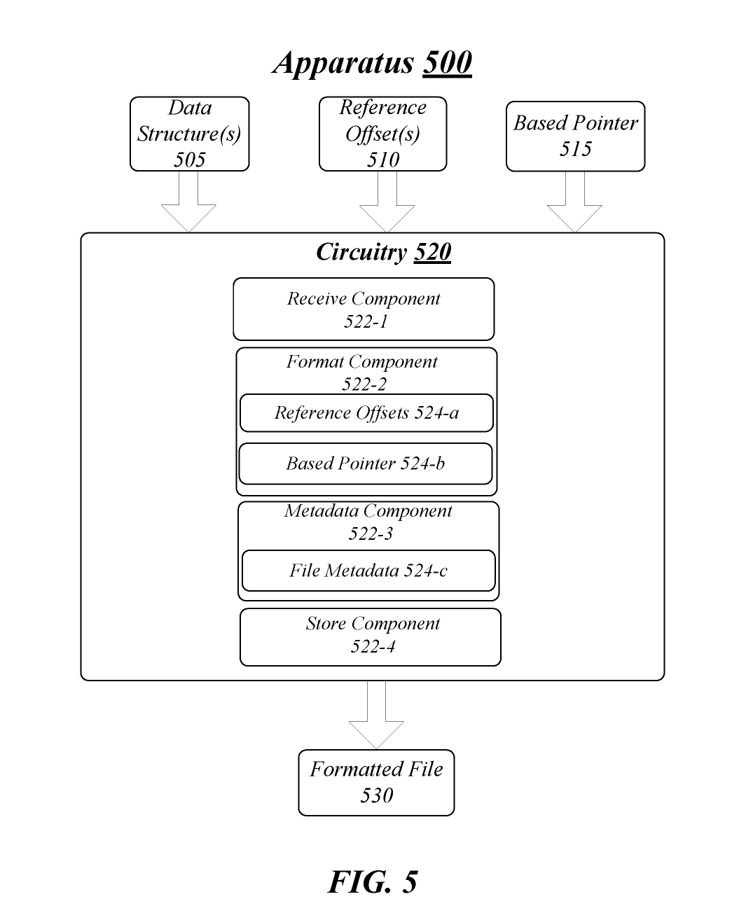

FIG. 5 illustrates an example block diagram for an apparatus 500. Although apparatus 500 shown in FIG. 5 has a limited number of elements in a certain topology, it may be appreciated that the apparatus 500 may include more or less elements in alternate topologies as desired for a given implementation.

The apparatus 500 may be supported by circuitry 520 and may be maintained or located at a computing device and may be arranged to execute or implement elements of a system such as system 100 shown in FIG. 1 and described above. Circuitry 520 may be arranged to execute one or more software or firmware implemented components or logic 522-a. It is worthy to note that “a” and “b” and “c” and similar designators as used herein are intended to be variables representing any positive integer. Thus, for example, if an implementation sets a value for a=4, then a complete set of software or firmware for components or logic 522-a may include components or logic 522-1, 522-2, 522-3 or 522-4. The examples presented are not limited in this context and the different variables used throughout may represent the same or different integer values. Also, these “components” or “logic” may be software/firmware stored in computer-readable media, and although the components are shown in FIG. 5 as discrete boxes, this does not limit these components to storage in distinct computer-readable media components (e.g., a separate memory, etc.).

According to some examples, circuitry 520 may include a processor or processor circuitry to implement logic and/or features that may format a file to store a memory representation of a data structure to persistent memory. The processor or processor circuitry can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 520 may also be an application specific integrated circuit (ASIC) and at least some components or logic 522-a may be implemented as hardware elements of the ASIC. In some examples, circuitry 520 may also include a field programmable gate array (FPGA) and at least some logic 522-a may be implemented as hardware elements of the FPGA.

According to some examples, apparatus 500 may include a receive component 522-1. Receive component 522-1 may be executed by circuitry 520 to receive a memory representation of a first data structure maintained in virtual addresses of a process virtual memory space for a computing device that may include apparatus 500. For these examples, the memory representation of the first data structure may be included in data structure(s) 505.

In some examples, apparatus 500 may also include a format component 522-2. Format component 522-2 may be executed by circuitry 520 to format a file to store the first data structure to persistent memory maintained at one or more memory devices coupled with the computing device. For these examples, the file may be formatted to include a first reference offset via which references in the first data structure are mapped to a first group of virtual addresses from among the virtual addresses. The first reference offset may be determined based on a based pointer for a starting virtual address of the process virtual memory space via which the first group of virtual addresses are offset according to the first reference offset.

In some examples, format component 522-2 may have received the first reference offset (e.g., from a compiler for the computing device including apparatus 500) via reference offset(s) 510. Format component 522-2 may maintain received reference offsets with reference offsets 524-a (e.g., in a lookup table (LUT)). Format component 522-2 may have received information related to the based pointer (e.g., from base registers) via based pointer 515. Format component 522-2 may maintain information for the based pointer with file base offset 524-b (e.g., in a LUT).

According to some examples, receive component 522-1 may also receive a memory representation of a second data structure maintained in virtual addresses of the process virtual memory space for the computing device that may include apparatus 500. For these examples, the memory representation of the second data structure may be included in data structure(s) 505. In some examples, apparatus 500 may also include a metadata component 522-3. Metadata component 522-3 may be executed by circuitry 520 to generate metadata to add to the formatted file that includes information to indicate the first reference offset and a persistent memory unit size of the first data structure and to indicate the second reference offset and a persistent memory unit size of the second data structure. Metadata component 522-3 may maintain information to be included in the metadata added to the formatted file in fine metadata 524-c (e.g., in a LUT).

In some examples, apparatus 500 may also include a store component 522-4. Store component 522-4 may be executed by circuitry 520 to cause the formatted file to be stored to the persistent memory. For these examples, the formatted file may be included in formatted file 530.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

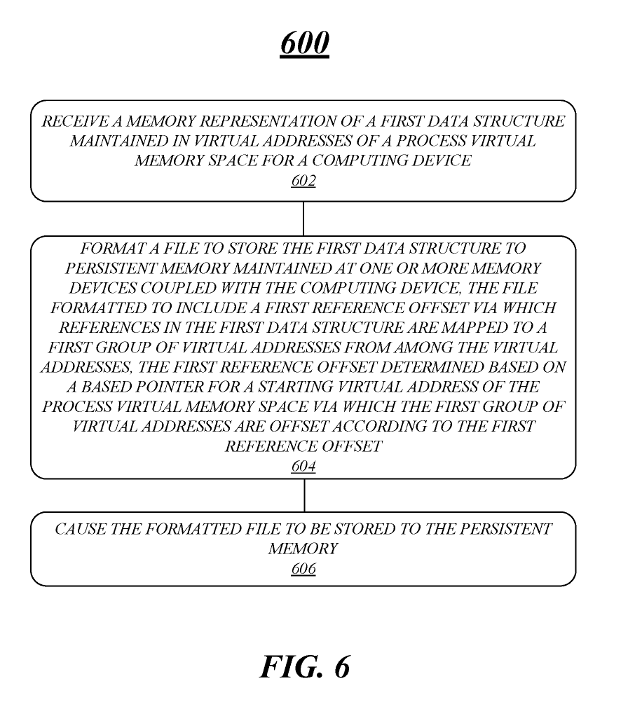

FIG. 6 illustrates an example logic flow 600. As shown in FIG. 6 the first logic flow includes a logic flow 600. Logic flow 600 may be representative of some or all of the operations executed by one or more logic, features, or devices described herein, such as apparatus 500. More particularly, logic flow 600 may be implemented by receive component 522-1, format component 522-2 or store component 522-3.

According to some examples, logic flow 600 at block 602 may receive a memory representation of a first data structure maintained in virtual addresses of a process virtual memory space for a computing device. For these examples, receive component 522-1 may receive the memory representation of the first data structure.

In some examples, logic flow 600 at block 604 may formatting a file to store the first data structure to persistent memory maintained at one or more memory devices coupled with the computing device, the file formatted to include a first reference offset via which references in the first data structure are mapped to a first group of virtual addresses from among the virtual addresses, the first reference offset determined based on a based pointer for a starting virtual address of the process virtual memory space via which the first group of virtual addresses are offset according to the first reference offset. For these example, format component 522-2 may format the file.

According to some examples, logic flow 600 at block 606 may cause the formatted file to be stored to the persistent memory. For these examples, store component 522-4 may cause the formatted file to be stored to the persistent memory.

In some examples, rather than copy the data structure to the persistent memory, a persistent memory file may be maintained based on allocated persistent memory being utilized by applications to create data structures in a mapped persistent memory file. For an allocated portion of the persistent memory that is mapped all reference offsets for these data structures may hold values that are offsets from a based pointer of the mapped persistent memory file. This may result in a single instance of these data structures existing in respective mapped persistent memory files and hence to need to copy.

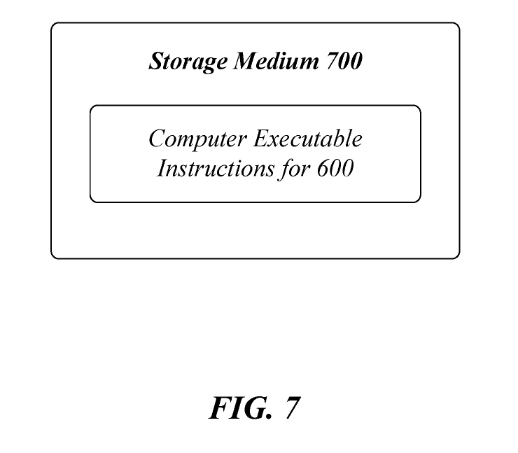

FIG. 7 illustrates an example storage medium 700. As shown in FIG. 7, the first storage medium includes a storage medium 700. The storage medium 700 may comprise an article of manufacture. In some examples, storage medium 700 may include any non-transitory computer readable medium or machine readable medium, such as an optical, magnetic or semiconductor storage. Storage medium 700 may store various types of computer executable instructions, such as instructions to implement logic flow 600. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

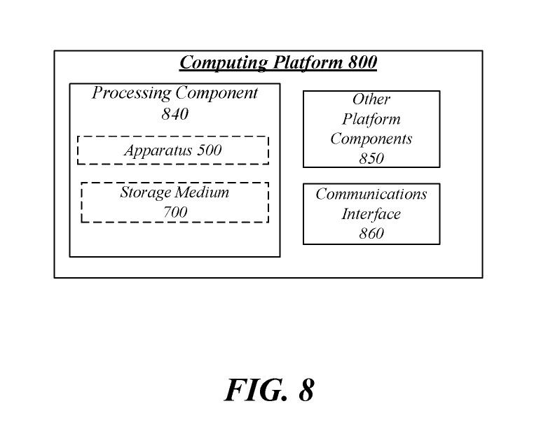

FIG. 8 illustrates an example computing platform 800. In some examples, as shown in FIG. 8, computing platform 800 may include a processing component 840, other platform components 850 or a communications interface 860. According to some examples, computing platform 800 may be a computing device having logic and/or features capable of formatting files from memory representations of data structures and causing the formatted file to be stored to persistent memory coupled with the computing device.

According to some examples, processing component 840 may execute processing operations or logic for apparatus 500 and/or storage medium 700. Processing component 840 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 850 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), RAM, DRAM, DDR DRAM, synchronous DRAM (SDRAM), DDR SDRAM, SRAM, programmable ROM (PROM), EPROM, EEPROM, flash memory, ferroelectric memory, SONOS memory, polymer memory such as ferroelectric polymer memory, nanowire, FeTRAM or FeRAM, ovonic memory, phase change memory, memristors, STT-MRAM, magnetic or optical cards, an array of devices such as Redundant Array of Independent Disks (RAID) drives, solid state memory devices (e.g., USB memory), solid state drives (SSD) and any other type of storage media suitable for storing information. In some examples, these types of memory units may be arranged as persistent memory and may be maintained in one or more DIMMs.

In some examples, communications interface 860 may include logic and/or features to support a communication interface. For these examples, communications interface 860 may include one or more communication interfaces that operate according to various communication protocols or standards to communicate over direct or network communication links. Direct communications may occur via use of communication protocols such as SMBus, PCIe, NVMe, QPI, SATA, SAS or USB communication protocols. Network communications may occur via use of communication protocols or standards related to IEEE 802.3, iWARP, Infiniband, RoCE, SATA, SCSI, SAS. Network communication may also occur according to one or more OpenFlow specifications such as the OpenFlow Hardware Abstraction API Specification.

Computing platform 800 may be part of a computing device that may be, for example, user equipment, a computer, a personal computer (PC), a desktop computer, a laptop computer, a notebook computer, a netbook computer, a tablet, a smart phone, embedded electronics, a gaming console, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of computing platform 800 described herein, may be included or omitted in various embodiments of computing platform 800, as suitably desired.

The components and features of computing platform 800 may be implemented using any combination of discrete circuitry, ASICs, logic gates and/or single chip architectures. Further, the features of computing platform 800 may be implemented using microcontrollers, programmable logic arrays and/or microprocessors or any combination of the foregoing where suitably appropriate. It is noted that hardware, firmware and/or software elements may be collectively or individually referred to herein as “logic”, “feature”, “component”, “circuit” or “circuitry.”

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

### Example 1

An example apparatus may include circuitry at a computing device. The apparatus may also include a receive component for execution by the circuitry to receive a memory representation of a first data structure maintained in virtual addresses of a process virtual memory space for a computing device. The apparatus may also include a format component for execution by the circuitry to format a file to store the first data structure to persistent memory maintained at one or more memory devices coupled with the computing device, the file formatted to include a first reference offset via which references in the first data structure are mapped to a first group of virtual addresses from among the virtual addresses. The first reference offset determined based on a based pointer for a starting virtual address of the process virtual memory space via which the first group of virtual addresses are offset according to the first reference offset. The apparatus may also include a store component for execution by the circuitry to cause the formatted file to be stored to the persistent memory.

### Example 2

The apparatus of example 1, the first data structure may be a binary search tree or a graph.

### Example 3

The apparatus of example 1, the receive component may receive a memory representation of a second data structure maintained in the virtual addresses of the process virtual memory space. The format component may format the file to store the second data structure to the persistent memory. The file formatted may also include a second reference offset via which references in the second data structure are mapped to a second group of virtual addresses from among the virtual addresses. The second reference offset may be determined based on the based pointer.

### Example 4

The apparatus of example 3 may also include a metadata component for execution by the circuitry to generate metadata to add to the formatted file that includes information to indicate the first reference offset and a persistent memory unit size of the first data structure and to indicate the second reference offset and a persistent memory unit size of the second data structure.

### Example 5

The apparatus of example 1, the first reference offset may be generated by a compiler for the computing device.

### Example 6

The apparatus of example 1, the based pointer may be determined based on one or more registers maintained with the circuitry for the computing device.

### Example 7

The apparatus of example 1, the persistent memory may be maintained at the one or more memory devices comprises the persistent memory capable of storing data structures such that the data structures continue to be accessible after the data structures are created and following a power loss to the one or more memory devices.

### Example 8

The apparatus of example 1, the one or more memory devices may be maintained on at least one DIMM coupled with the host computing device.

### Example 9

The apparatus of example 1, the one or more memory devices may include volatile or non-volatile memory.

### Example 10

The apparatus of example 9, the volatile memory may include RAM, DRAM, DDR SDRAM, SRAM, T-RAM or Z-RAM.

### Example 11

The apparatus of example 9, the non-volatile memory may include phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

### Example 12

The apparatus of example 1 may also include one or more of a network interface communicatively coupled to the apparatus, a battery coupled to the apparatus or a display communicatively coupled to the apparatus.

### Example 13

An example method may include receiving a memory representation of a first data structure maintained in virtual addresses of a process virtual memory space for a computing device. The method may also include formatting a file to store the first data structure to persistent memory maintained at one or more memory devices coupled with the computing device, the file formatted to include a first reference offset via which references in the first data structure are mapped to a first group of virtual addresses from among the virtual addresses. The first reference offset may be determined based on a based pointer for a starting virtual address of the process virtual memory space via which the first group of virtual addresses are offset according to the first reference offset. The method may also include causing the formatted file to be stored to the persistent memory.

### Example 14

The method of example 13, the first data structure may be a binary search tree or a graph.

### Example 15

The method of example 13 may also include receiving a memory representation of a second data structure maintained in the virtual addresses of the process virtual memory space. The method may also include formatting the file to store the second data structure to the persistent memory, the file formatted to also include a second reference offset via which references in the second data structure are mapped to a second group of virtual addresses from among the virtual addresses. The second reference offset may be determined based on the based pointer.

### Example 16

The method of example 15 may also include generating metadata to add to the formatted file that includes information to indicate the first reference offset and a persistent memory unit size of the first data structure and to indicate the second reference offset and a persistent memory unit size of the second data structure.

### Example 17

The method of example 13, the first reference offset may be generated by a compiler for the computing device.

### Example 18

The method of example 13, the based pointer may be determined based on one or more registers maintained with circuitry for the computing device.

### Example 19

The method of example 13, the persistent memory may be maintained at the one or more memory devices comprises the persistent memory capable of storing data structures such that the data structures continue to be accessible after the data structures are created and following a power loss to the one or more memory devices.

### Example 20

The method of example 13, the one or more memory devices may be maintained on at least one DIMM coupled with the host computing device.

### Example 21

The method of example 13, the one or more memory devices may include volatile or non-volatile memory.

### Example 22

The method of example 21, the volatile memory may include RAM, DRAM, DDR SDRAM, SRAM, T-RAM or Z-RAM.

### Example 23

The method of example 21, the non-volatile memory may include phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

### Example 24

An example at least one machine readable medium may include a plurality of instructions that in response to being executed by a system may cause the system to carry out a method according to any one of examples 13 to 23.

### Example 25

An example apparatus may include means for performing the methods of any one of examples 13 to 23.

### Example 26

An example at least one machine readable medium may include a plurality of instructions that in response to being executed by a system at a computing device may cause the system to receive a memory representation of a first data structure maintained in virtual addresses of a process virtual memory space for a computing device. The instructions may also cause the system to format a file to store the first data structure to persistent memory maintained at one or more memory devices coupled with the computing device. The file may be formatted to include a first reference offset via which references in the first data structure are mapped to a first group of virtual addresses from among the virtual addresses. The first reference offset may be determined based on a based pointer for a starting virtual address of the process virtual memory space via which the first group of virtual addresses are offset according to the first reference offset. The instructions may also cause the system to cause the formatted file to be stored to the persistent memory.

### Example 27

The at least one machine readable medium of example 26, the first data structure may be a binary search tree or a graph.

### Example 28

The at least one machine readable medium of example 26, the instructions may further cause the system to receive a memory representation of a second data structure maintained in the virtual addresses of the process virtual memory space. The instructions may also cause the system to format the file to store the second data structure to the persistent memory. The file may be formatted to also include a second reference offset via which references in the second data structure are mapped to a second group of virtual addresses from among the virtual addresses. The second reference offset may be determined based on the based pointer.

### Example 29

The at least one machine readable medium of example 28, the instructions may further cause the system to generate metadata to add to the formatted file that includes information to indicate the first reference offset and a persistent memory unit size of the first data structure and to indicate the second reference offset and a persistent memory unit size of the second data structure.

### Example 30

The at least one machine readable medium of example 26, the first reference offset may be generated by a compiler for the computing device.

### Example 31

The at least one machine readable medium of example 26, the based pointer may be determined based on one or more registers maintained with circuitry for the computing device.

### Example 32

The at least one machine readable medium of example 26, the persistent memory may be maintained at the one or more memory devices comprises the persistent memory capable of storing data structures such that the data structures continue to be accessible after the data structures are created and following a power loss to the one or more memory devices.

### Example 33

The at least one machine readable medium of example 26, the one or more memory devices may be maintained on at least one DIMM coupled with the host computing device.

### Example 34

The at least one machine readable medium of example 26, the one or more memory devices may include volatile or non-volatile memory.

### Example 35

The at least one machine readable medium of example 34, volatile memory may include RAM, DRAM, DDR SDRAM, SRAM, T-RAM or Z-RAM.

### Example 36

The at least one machine readable medium of example 34, the non-volatile memory may include phase change memory that uses chalcogenide phase change material, flash memory, ferroelectric memory, SONOS memory, polymer memory, ferroelectric polymer memory, FeTRAM, FeRAM, ovonic memory, nanowire, EEPROM, phase change memory, memristors or STT-MRAM.

In the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus comprising:
circuitry at a computing device;
a receive component for execution by the circuitry to receive a memory representation of a first data structure maintained in virtual addresses of a process virtual memory space for a computing device;
a format component for execution by the circuitry to format a file to store the first data structure to persistent memory maintained at one or more memory devices coupled with the computing device, the file formatted to include a first reference offset via which references in the first data structure are mapped to a first group of virtual addresses from among the virtual addresses, the first reference offset determined based on a based pointer for a starting virtual address of the process virtual memory space via which the first group of virtual addresses are offset according to the first reference offset; and
a store component for execution by the circuitry to cause the formatted file to be stored to the persistent memory.

2. The apparatus of claim 1 the first data structure comprising a binary search tree or a graph.

3. The apparatus of claim 1, comprising:
the receive component to receive a memory representation of a second data structure maintained in the virtual addresses of the process virtual memory space; and
the format component to format the file to store the second data structure to the persistent memory, the file formatted to also include a second reference offset via which references in the second data structure are mapped to a second group of virtual addresses from among the virtual addresses, the second reference offset determined based on the based pointer.

4. The apparatus of claim 3, comprising:
a metadata component for execution by the circuitry to generate metadata to add to the formatted file that includes information to indicate the first reference offset and a persistent memory unit size of the first data structure and to indicate the second reference offset and a persistent memory unit size of the second data structure.

5. The apparatus of claim 1, comprising the based pointer determined based on one or more registers maintained with the circuitry for the computing device.

6. The apparatus of claim 1, the persistent memory maintained at the one or more memory devices comprises the persistent memory capable of storing data structures such that the data structures continue to be accessible after the data structures are created and following a power loss to the one or more memory devices.

7. The apparatus of claim 1, the one or more memory devices maintained on at least one dual in-line memory module (DIMM) coupled with the host computing device.

8. The apparatus of claim 1, the one or more memory devices include volatile or non-volatile memory, the volatile memory including random-access memory (RAM), Dynamic RAM (D-RAM), double data rate synchronous dynamic RAM (DDR SDRAM), static random-access memory (SRAM), thyristor RAM (T-RAM) or zero-capacitor RAM (Z-RAM) and the non-volatile memory including phase change memory that uses chalcogenide phase change material, flash memory, ferroelectric memory, silicon-oxide-nitride-oxide-silicon (SONOS) memory, polymer memory, ferroelectric polymer memory, ferroelectric transistor random access memory (FeTRAM or FeRAM), ovonic memory, nanowire, electrically erasable programmable read-only memory (EEPROM), phase change memory, memristors or spin transfer torque-magnetoresistive random access memory (STT-MRAM).

9. The apparatus of claim 1, comprising one or more of:
a network interface communicatively coupled to the apparatus;
a battery coupled to the apparatus; or
a display communicatively coupled to the apparatus.

10. A method comprising:
receiving a memory representation of a first data structure maintained in virtual addresses of a process virtual memory space for a computing device;
formatting a file to store the first data structure to persistent memory maintained at one or more memory devices coupled with the computing device, the file formatted to include a first reference offset via which references in the first data structure are mapped to a first group of virtual addresses from among the virtual addresses, the first reference offset determined based on a based pointer for a starting virtual address of the process virtual memory space via which the first group of virtual addresses are offset according to the first reference offset; and
causing the formatted file to be stored to the persistent memory.

11. The method of claim 10, the first data structure comprising a binary search tree or a graph.

12. The method of claim 10, comprising:
receiving a memory representation of a second data structure maintained in the virtual addresses of the process virtual memory space; and
formatting the file to store the second data structure to the persistent memory, the file formatted to also include a second reference offset via which references in the second data structure are mapped to a second group of virtual addresses from among the virtual addresses, the second reference offset determined based on the based pointer.

13. The method of claim 12, comprising:
generating metadata to add to the formatted file that includes information to indicate the first reference offset and a persistent memory unit size of the first data structure and to indicate the second reference offset and a persistent memory unit size of the second data structure.

14. The method of claim 10, comprising the first reference offset generated by a compiler for the computing device.

15. The method of claim 10, comprising the based pointer determined based on one or more registers maintained with circuitry for the computing device.

16. The method of claim 10, the persistent memory maintained at the one or more memory devices comprises the persistent memory capable of storing data structures such that the data structures continue to be accessible after the data structures are created and following a power loss to the one or more memory devices.

17. The method of claim 10, wherein the one or more memory devices include volatile or non-volatile memory, the volatile memory including random-access memory (RAM), Dynamic RAM (D-RAM), double data rate synchronous dynamic RAM (DDR SDRAM), static random-access memory (SRAM), thyristor RAM (T-RAM) or zero-capacitor RAM (Z-RAM) and the non-volatile memory including phase change memory that uses chalcogenide phase change material, flash memory, ferroelectric memory, silicon-oxide-nitride-oxide-silicon (SONOS) memory, polymer memory, ferroelectric polymer memory, ferroelectric transistor random access memory (FeTRAM or FeRAM), ovonic memory, nanowire, electrically erasable programmable read-only memory (EEPROM), phase change memory, memristors or spin transfer torque-magnetoresistive random access memory (STT-MRAM).

18. At least one machine readable medium comprising a plurality of instructions that in response to being executed by a system at a computing device cause the system to:
receive a memory representation of a first data structure maintained in virtual addresses of a process virtual memory space for a computing device;
format a file to store the first data structure to persistent memory maintained at one or more memory devices coupled with the computing device, the file formatted to include a first reference offset via which references in the first data structure are mapped to a first group of virtual addresses from among the virtual addresses, the first reference offset determined based on a based pointer for a starting virtual address of the process virtual memory space via which the first group of virtual addresses are offset according to the first reference offset; and
cause the formatted file to be stored to the persistent memory.

19. The at least one machine readable medium of claim 18, the first data structure comprising a binary search tree or a graph.

20. The at least one machine readable medium of claim 18, comprising the instructions to further cause the system to:
receive a memory representation of a second data structure maintained in the virtual addresses of the process virtual memory space; and
format the file to store the second data structure to the persistent memory, the file formatted to also include a second reference offset via which references in the second data structure are mapped to a second group of virtual addresses from among the virtual addresses, the second reference offset determined based on the based pointer.

21. The at least one machine readable medium of claim 20, comprising the instructions to further cause the system to:
generate metadata to add to the formatted file that includes information to indicate the first reference offset and a persistent memory unit size of the first data structure and to indicate the second reference offset and a persistent memory unit size of the second data structure.

22. The at least one machine readable medium of claim 18, comprising the first reference offset generated by a compiler for the computing device.

23. The at least one machine readable medium of claim 18, comprising the based pointer determined based on one or more registers maintained with circuitry for the computing device.

24. The at least one machine readable medium of claim 18, the persistent memory maintained at the one or more memory devices comprises the persistent memory capable of storing data structures such that the data structures continue to be accessible after the data structures are created and following a power loss to the one or more memory devices.

25. The at least one machine readable medium of claim 18, the one or more memory devices maintained on at least one dual in-line memory module (DIMM) coupled with the host computing device.
